(19) United States
(12) Patent Application Publication
(10) Pub. No.: US 2002/0193101 A1
(43) Pub. Date: Dec. 19, 2002

(54) Configuring a portable device

(76) Inventor: Paul McAlinden, Austin, TX (US)

Correspondence Address: Timothy N. Trop, TROP, PRUNER & HU, P.C., STE 100, 8554 KATY FWY, HOUSTON, TX, 77024-1805, US

(21) Appl. No.: 09/882,759

(22) Filed: Jun. 15, 2001

(51) Int. Cl. H04M 3/00

(52) U.S. Cl. 455/419; 455/418; 455/551

(57) ABSTRACT

A way of configuring a portable device is provided. A portable device comprises a storage unit and a control unit that is communicatively coupled to the storage unit. The control unit is provided to determine whether configuration of the portable device is desired, request configuration information in response to determining that configuration is desired, and receive the requested configuration information.

### BACKGROUND

This invention relates generally to configuring a portable device, and, more particularly, to configuring the portable device to an operable state.

Portable electronic devices of various types have become prevalent for everyday use. For example, it is not uncommon to find consumers today using cellular phones, personal digital assistants (PDAs), pagers, portable music players such as MP3 (Moving Pictures Expert Group, Layer 3) players, and other types of music players.

Portable devices of the current generation are generally more flexible and robust than their predecessors. For example, modern wireless phones may provide a functionality of a calculator, pager, music player, and the like in addition to the conventional telecommunications capability. As more and more new features are developed for the current generation of portable devices, it may be desirable to routinely upgrade the configuration of the portable devices to support these added features. However, upgrading the configuration of a portable device may involve some inherent risks, such as the risk of rendering the portable device inoperable because of a faulty upgrade or unsuccessful transfer. As a result, the user may have to return the portable device to a dealer or otherwise mail it to a repair service in order to restore it to an operational condition.

Thus, there is a need for an improved manner of configuring a portable device.

### BRIEF DESCRIPTION OF THE DRAWINGS

The invention may be understood by reference to the following description taken in conjunction with the accompanying drawings, in which like reference numerals identify like elements, and in which:

FIG. 1 is a stylized block diagram of a communications system, in accordance with one embodiment of the present invention;

FIG. 2 is a block diagram of a portable device that may be employed in the communications system of FIG. 1, in accordance with one embodiment of the present invention;

FIG. 3 is a flow diagram of a method that may be employed by the portable device of FIG. 2, in accordance with one embodiment of the present invention; and

FIG. 4 is a flow diagram of an alternative method that may be employed by the portable device of FIG. 2, in accordance with one embodiment of the present invention.

### DETAILED DESCRIPTION

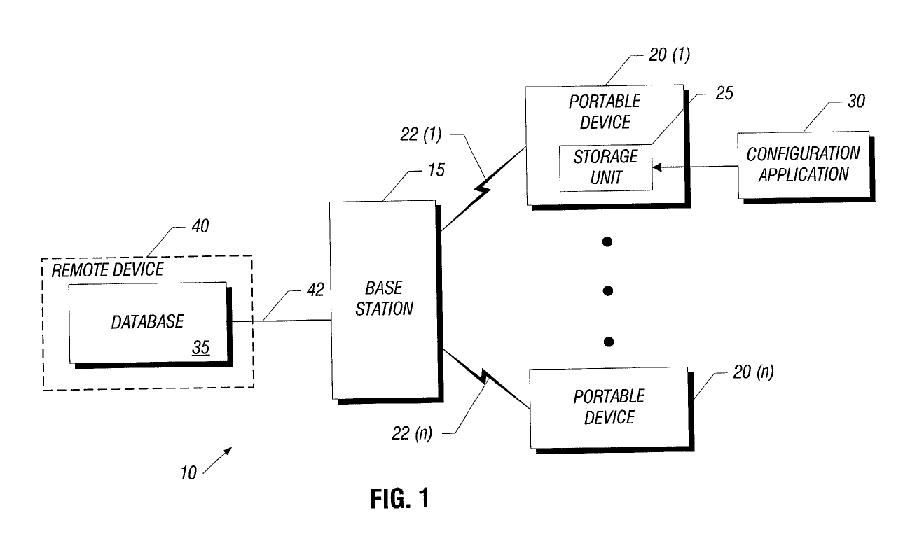

Referring now to FIG. 1, a block diagram of a communications system 10 is illustrated. The communications system 10, in one embodiment, includes a base station 15 that communicates with one or more of portable devices 20(1-n) over one or more connections 22(1-n). In one embodiment, the connections 22(1-n) may be wireless connections. The portable devices 20(1-n), in one embodiment, may be wireless phones, computers, personal digital assistants (PDAs), pagers, portable music players, or any other device capable of receiving configuration information (described in more detail below) over one or more of the communications links 22(1-n). In one embodiment, the portable devices 20(1-n) may be readily transportable devices, such as hand-held devices. The portable devices 20(1-n), in one embodiment, may be battery-powered devices where the battery serves as the main power supply for the portable devices 20(1-n) for the duration during which no electrical power is supplied from an external, fixed power source, such as an electrical outlet.

In one embodiment, one or more of the portable devices 20(1-n) may include a storage unit 25 on which a configuration application 30 may be stored. As described in more detail below, the configuration application 30, when executed, may, in one embodiment, allow one or more of the portable devices 20(1-n) to receive configuration information over one or more of the communications links 22(1-n), where the configuration information may be used to configure the portable devices 20(1-n). In one embodiment, the configuration information defines one or more operating characteristics of the portable device 20(1-n), and, as such, may include at least a portion of an operating system, protocol stack, or standard application layer. In one embodiment, the configuration information may be software upgrade that defines one or more “features” of the portable device 20(1-n). The configuration information, for example, may be retrieved from a database 35 of a remote device (or system) 40.

The remote device 40, in one embodiment, is coupled to the base station 15 over a communications link 42. Although not so limited, the communications link 42 in the illustrated embodiment is a wired link. In another embodiment, the communications link 42 may be a wireless link, for example. The remote device 40, in one embodiment, may be any processor-based device that is capable of receiving a request for configuration information from a portable device 20(1-n) and then transmitting the requested configuration information to the requesting portable device 20(1-n).

It should be noted that the configuration of the illustrated embodiment of the communications system 10 of FIG. 1 is provided as an example, and that, in other embodiments, one of a variety of configurations may be employed. For example, in one embodiment, the remote device 40 may communicate directly with one or more of the portable devices 20(1-n) (i.e., as opposed to through the base station 15). In one embodiment, the communications system 10 may include more than one base station 15, where, for example, each base station may support a communications link with one or more of the portable devices 20(1-n) for a specified geographical region. Similarly, other configurations may be employed without deviating from the spirit and scope of one or more embodiments of the present invention.

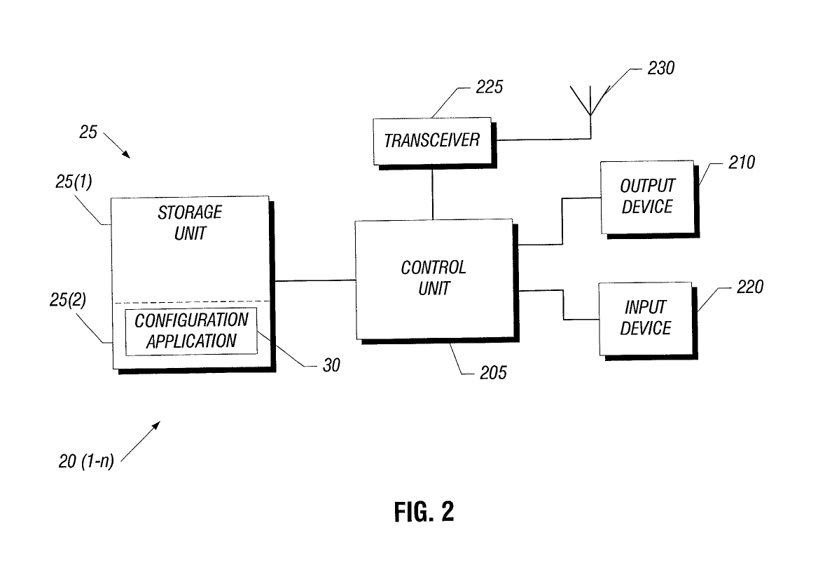

Referring now to FIG. 2, a block diagram of the portable device 20(1-n) of FIG. 1 is illustrated in accordance with one embodiment of the present invention. The portable device 20(1-n), in one embodiment, includes a control unit 205 that is communicatively coupled to the storage unit 25. In one embodiment, the storage unit 25 may be a flash memory. The storage unit 25, in one embodiment, includes a first portion 25(1) and a second portion 25(2), where the first portion 25(1) may be capable of storing configuration information received by the portable device 20(1-n) and where the second portion 25(2) may be a protected region of the storage unit 25 that is capable of storing the configuration application 30 (see FIG. 1). In one embodiment, the second portion 25(2) of the storage unit 25 may be a reserved (i.e., not necessarily protected) memory region in which the configuration application 30 is stored.

The control unit 205, in one embodiment, is capable of being coupled to an output device 210 and an input device 220. The output device 210 may be any device capable of outputting information to the user, and may take one of several forms. For example, the output device 210 may be a display panel of the portable device 20(1-n). As an added example, the output device 210 may be a speaker of the portable device.

The input device 220, in one embodiment, allows users to input information into the portable device 20(1-n). The input device 220, for example, may be a keypad, microphone, and the like. In an alternative embodiment, the input device 220 may take one of several other forms.

The portable device 20(1-n), in one embodiment, includes a transceiver 225 that is communicatively coupled to an antenna 230. The transceiver 225 may be capable of transmitting and receiving information. For example, in one embodiment, as described in more detail below, the transceiver 225 receives the configuration information from the database 35 (see FIG. 1). In one embodiment, where transmission of information may not be desirable or needed, a receiver instead of the transceiver 225 may be employed.

It should be noted that configuration of the portable device 20(1-n) is illustrative only, and that in alternative embodiments, other configurations may be employed. For example, in an alternate embodiment, additional components (such as bridges or other integrated circuits) may be present between the control unit 205 and one or more of the devices 210 and 220. Similarly, other components (such as buffers, caches or other circuitry) may be employed between the control unit 205 and the storage unit 25. Furthermore, although in the illustrated embodiment a single storage unit 25 is shown having two portions 25(1) and 25(2), in other embodiments, the two portions 25(1-2) may each be a separate storage unit. In one embodiment, the output and input devices 210, 220 may be integrated in a single device, such as a touch-sensitive display device. Similarly, other configurations of the portable device 20(1-n) may be employed without deviating from the spirit and/or scope of one or more embodiments of the present invention.

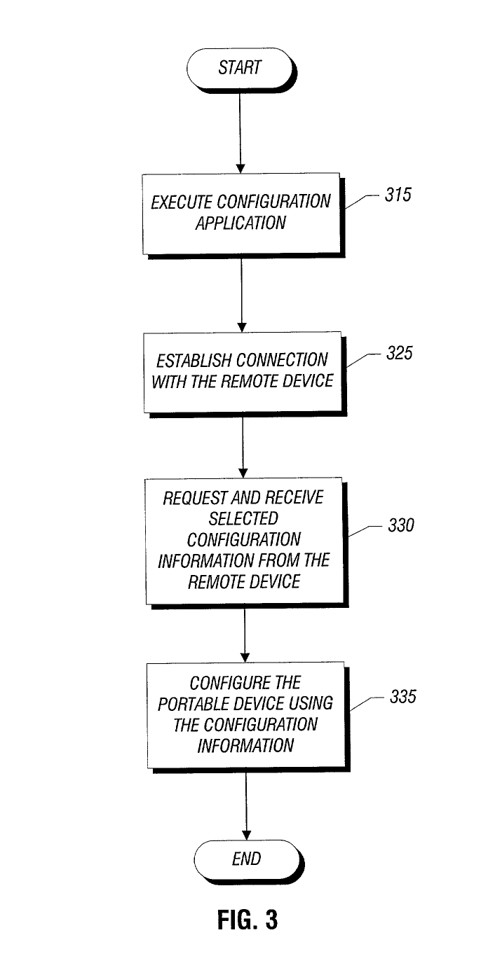

Referring now to FIG. 3, a flow diagram of a method that may be employed by the portable device 20(1-n) of FIG. 2 is illustrated. The portable device 20(1-n) executes (at 315) the configuration application 30 (see FIG. 1). The portable device 20(1-n) establishes a connection with the remote device 40 (see FIG. 1). In one embodiment, the connection may be a secured connection to reduce the possibility of unauthorized tampering. Once the connection is established (at 325) with the remote device 40 (see FIG. 1), the portable device 20(1-n), in one embodiment, requests and receives (at 330) selected configuration information from the database 35 of the remote device 40. The selected “configuration information,” in one embodiment, may be any desirable version (e.g., upgrade or previous version) of software of the portable device 20(1-n). In one embodiment, the “configuration information” may include information to reconfigure (sometimes referred to as “reconfiguration information”) the portable device 20(1-n) to a previous, operable state. A portable device 20(1-n) may require reconfiguration to an “operable” state, for example, after an unsuccessful attempt to upgrade (either because of a transmission problem or a faulty upgrade version) the portable device 20(1-n).

The selected configuration information received (at 330) is then used to configure (at 335) the portable device 20(1-n), in one embodiment. The process of configuring (at 335) the portable device 20(1-n) may, in one embodiment, require the portable device 20(1-n) to be reinitialized.

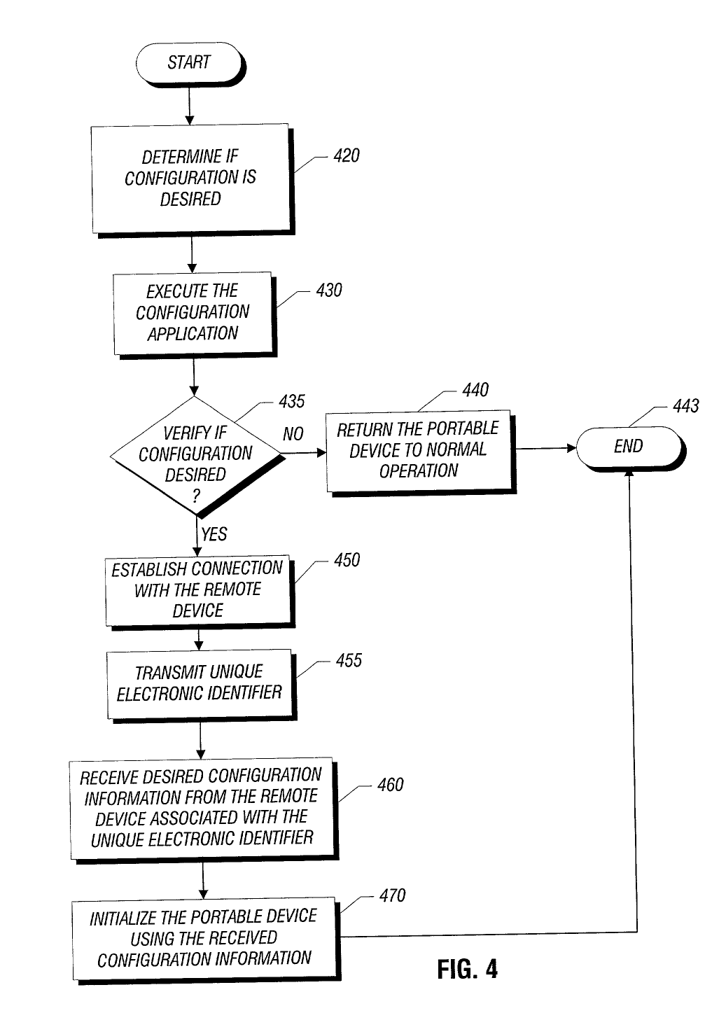

Referring now to FIG. 4, a flow diagram of an alternative method that may be employed by the portable device 20(1-n) of FIG. 2 is illustrated. The portable device 20(1-n) determines if configuration is desired. The portable device 20(1-n) may determine (at 420) if configuration is desirable in one of several ways. For example, the portable device 20(1-n) itself may detect initialization problems or operational problems after a software update. In an alternative embodiment, a user may indicate using the input device 220 (see FIG. 2) that configuration is desirable, wherein the portable device 20(1-n) then detects the user's indication. For example, the user may select a “master reset” button on the portable device 20(1-n) to indicate that reconfiguration of the portable device 20(1-n) is desired. In yet another embodiment, the base station 15 (see FIG. 1) may detect a problem with the portable device 20(1-n) and generate an indication that configuration may be desired.

The control unit 205, in one embodiment, executes (at 430) the configuration application 30 (see FIG. 2) that is stored in the second portion 25(2) of the storage unit 25 (see FIG. 2) in response to determining (at 420) that configuration is desired. The portable device 20(1-n), in one embodiment, prompts the user to verify (at 435) if configuration is desired. The verification may occur in the form of prompting the user with a question to confirm that configuration is desired. In one embodiment, the user may respond to the verification question using the input device 220 (see FIG. 2).

If the user does not wish to configure the portable device 20(1-n), then the portable device 20(1-n) is returned (at 440) to a normal operation state, at which point the method may terminate (at 443). The user, in one embodiment, may thereafter utilize the phone in its normal capacity.

If the user verifies (at 435) that configuration of the portable device 20(1-n) is desired, then the configuration application 30 establishes (at 450) a connection with the remote device 40 (see FIG. 1). Upon establishing (at 450) a connection with the remote device, the portable device 20(1-n), in one embodiment, transmits (at 455) a unique electronic identifier to the remote device 40, where the unique electronic identifier serves to identify the portable device 20(1-n) to the remote device 40. The unique electronic identifier, for example, may be the serial number of the portable device 20(1-n).

Based on the transmitted (at 455) unique electronic identifier, the remote device 40 may identify configuration information stored in the database 35 (see FIG. 1) associated with the unique electronic identifier and may then transmit the identified configuration information to the portable device 20(1-n). The portable device 20(1-n), in one embodiment, receives (at 460) the configuration information from the database 35 of the remote device 40.

In one embodiment, before or during the transfer of the configuration information from the remote device 40 to the portable device 20(1-n), the portable device 20(1-n) may suggest to the user to place the portable device 20(1-n) in a battery recharger, as, depending on the amount of configuration information, the transfer may take a substantial amount of time. Additionally, in one embodiment, it may be desirable to inform the user to place the portable device 20(1-n) in an area with good reception to reduce the possibility of unexpected drops in communication links.

Once the configuration information is received (at 460), the portable device 20(1-n) is initialized (at 470) with the received configuration information. The portable device 20(1-n) may, in one embodiment, require a re-boot before the new configuration takes effect.

One or more embodiments of the present invention enable a user to configure a portable device 20(1-n) in an efficient manner. For example, a malfunctioning portable device 20(1-n), in one embodiment, may readily be restored to a known, good configuration without the need of returning the phone to a dealer or to a repair service office, and may thereby result in savings of time and money.

The various system layers, routines, or modules may be executable control units (such as control unit 205 (see FIG. 2)). Each control unit may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A portable device, comprising:
a storage unit; and
a control unit communicatively coupled to the storage unit, the control unit to determine whether configuration of the portable device is desired, request configuration information in response to determining that configuration is desired, and receive the requested configuration information.

2. The portable device of claim 1, wherein the control unit further initializes the portable device using at least a portion of the configuration information.

3. The portable device of claim 1, wherein the control unit to determine whether configuration is desired comprises the control unit to detect an indication to upgrade the configuration of the portable device.

4. The portable device of claim 1, wherein the control unit establishes a communication link with a remote device to receive the configuration information.

5. The portable device of claim 1, wherein the control unit stores the configuration information in a storage unit.

6. The portable device of claim 1, wherein the control unit receives at least one of an operating system, protocol stack layer, and application layer of the portable device.

7. The portable device of claim 1, wherein the control unit determines whether restoration of the portable device to an operation state is desired.

8. A method, comprising:
determining if configuration of a portable device is desired;
executing one or more instructions on the portable device to receive configuration information in response to determining that configuration of the portable device is desired; and
storing the received configuration information in the portable device.

9. The method of claim 8, further comprising initializing the portable device with at least a portion of the received configuration information.

10. The method of claim 8, comprising establishing a wireless connection with a remote device, transmitting a unique identifier associated with the portable device, and receiving configuration information from the remote device associated with the unique identifier.

11. The method of claim 8, wherein determining if configuration is desired comprises detecting an indication to reconfigure the portable device.

12. The method of claim 8, wherein storing the received configuration information comprises storing at least one of an operating system, protocol stack, and application layer of the portable device.

13. An article comprising one or more machine-readable storage media containing instructions that when executed enable a processor to:
request configuration information from a remote device;
store the configuration information in response to requesting the configuration information; and
configure a portable device using the configuration information.

14. The article of claim 13, wherein the instructions when executed enable the processor to request configuration information in response to detecting an indication to reconfigure the portable device.

15. The article of claim 13, wherein the instructions when executed enable the processor to transmit a unique identifier associated with the portable device and receive the configuration information associated with the unique identifier.

16. The article of claim 13, wherein the instructions when executed enable the processor to initialize the portable device using at least a portion of the configuration information.

17. The article of claim 13, wherein the instructions when executed enable the processor to store information to upgrade the configuration of the portable device.

18. The article of claim 13, wherein the instructions when executed enable the processor to store at least one of an operating system, protocol stack, and application layer of the portable device.

19. A wireless phone, comprising:
a storage unit; and
a control unit communicatively coupled to the storage unit, the controller to detect an indication to reconfigure the wireless phone, request reconfiguration information, store the reconfiguration information in the storage unit, and initialize the wireless phone with the reconfiguration information.

20. The wireless phone of claim 19, wherein the control unit receives the reconfiguration information from a remote device over a wireless link.

21. The wireless phone of claim 19, wherein the control unit requests reconfiguration information associated with a serial number of the wireless phone.

22. The wireless phone of claim 19, wherein the control unit initializes the wireless phone with an earlier version of the reconfiguration information.

23. A wireless phone of claim 19, wherein the control unit stores at least one of an operating system, protocol stack, and application layer of the wireless phone.

24. A method, comprising:
receiving an indication to reconfigure the wireless phone;
requesting reconfiguration information from a remote device based in response to receiving the indication; and
storing the reconfiguration information in a storage unit of the wireless phone.

25. The method of claim 24, further comprising initializing the wireless phone using at least a portion of the reconfiguration information.

26. The method of claim 25, wherein storing the reconfiguration information further comprises receiving the reconfiguration information over a wireless link.

27. The method of claim 24, wherein storing the reconfiguration information comprises storing reconfiguration information associated with an earlier version of at least one of an operating system, protocol stack, and application layer.

28. The method of claim 24, wherein requesting the reconfiguration information comprises transmitting a unique identifier associated with the wireless phone.

29. A system, comprising:
a storage unit to store configuration information associated with a portable device; and
a control unit communicatively coupled to the system, the controller to receive a request to transmit the configuration information to the portable device in response to receiving the request.

30. The system of claim 29, wherein the control unit identifies configuration information associated with a unique identifier associated with the portable device and transmits the identified configuration information to the portable device.
